(19) United States
(12) Patent Application Publication
(10) Pub. No.: US 2009/0066732 A1
(43) Pub. Date: Mar. 12, 2009

(54) LCD PANEL DRIVING CIRCUIT

(75) Inventor: Kenichi Miyamoto, Miazaki (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 12/173,539

(22) Filed: Jul. 15, 2008

(30) Foreign Application Priority Data
Sep. 10, 2007 (JP) 2007-234412

(51) Int. Cl. G09G 5/10

(52) U.S. Cl. 345/690

(57) ABSTRACT

The present invention provides an LCD panel driving circuit capable of suppressing unevenness in gradation even by a centralized amplifier system. In the LCD panel driving circuit, a source driver includes source terminals. The source terminals are sectioned into three source terminal groups. Decoder groups, bus wirings and amplifier groups are respectively assigned to the three source terminal groups by ones, and the LCD panel is driven by a centralized amplifier system every section.

### BACKGROUND OF THE INVENTION

The present invention relates to an LCD panel driving circuit.

Circuits each of which drives an LCD panel (liquid crystal panel) by gradation voltages of plural levels have heretofore been proposed in various ways (refer to, for example, a patent document 1 (Japanese Unexamined Patent Publication No. 2003-122325)).

For example, a distributed amplifier system and a centralized amplifier system are known as LCD panel driving circuits (source drivers). An LCD panel driving circuit 100A of a distributed amplifier system is shown in FIG. 10, and an LCD panel driving circuit 100B′ of a centralized amplifier system is shown in FIG. 11. Incidentally, both of them are of an LCD panel driving circuit which drives an LCD panel of a QVGA (resolution: 320×240) size by gradation voltages of 64 gray levels by way of example.

As shown in FIG. 10, the LCD panel driving circuit 100A of the distributed amplifier system includes amplifiers a1 through a960 provided for source terminals s1 through s960 corresponding to 320×3 (number of pixels in a lateral direction×three colors of RGB)=960, and a decoder group dec including 960 decoders provided corresponding to the respective amplifiers. Each of the decoders comprises 64 switches corresponding to the number of gray levels although not shown in the figure. Gradation voltages of 1 to 64 gray levels outputted from an unillustrated gradation potential output circuit are respectively inputted to the switches. The decoder turns ON any of the switches according to image data and outputs a gradation voltage to its corresponding amplifier. Each source terminal is connected to the source of a TFT (Thin Film Transistor) although not shown in the figure. When the gate of the TFT is turned ON by an unillustrated gate driver, the liquid crystal capacitance of each pixel thereof is charged by a gradation voltage outputted to the source terminal s1.

As shown in FIG. 11, the LCD panel driving circuit 100B of the centralized amplifier system includes amplifiers a1 through a64 corresponding to 64 gray levels, and a decoder group dec similar to FIG. 10. The respective amplifiers a1 through a64 are respectively inputted with tap1 through tap64 from an unillustrated gradation voltage output circuit. The operation of each decoder is similar to each of the decoders employed in FIG. 10. The decoder comprises 64 switches. The switches are respectively connected to wirings L1 through L64. Output terminals k1 through k64 of the amplifiers a1 through a64 are connected to the wirings L1 through L64 respectively. Thus, when any of the switches of the decoders, which corresponds to a source terminal s1 is selected and turned ON according to an image, for example, any of the output terminals k1 through k64 of the amplifiers is connected to the source terminal s1, so that the gradation voltage corresponding to the turned-ON switch is outputted to the corresponding source terminal.

FIG. 12 shows a specific configuration of each amplifier employed in the LCD panel driving circuits 100A and 100B. The amplifier comprises a rail-to-rail difference input stage 102, and a CMOD 104 comprised of a p channel MOS-FET 104p and an n channel MOS-FET 104n. Incidentally, since there is a possibility of all channels (960) being driven by one amplifier in the case of the centralized amplifier system, it is necessary to use an amplifier higher in drive capacity than the distributed amplifier system.

While speeding-up is enabled because each amplifier drives the liquid crystal capacitance of one pixel in the case of the distributed amplifier system, the amplifiers are required by the number of source terminals so that current consumption increases, thus placing a heavy load on a power circuit.

On the other hand, since the load of each amplifier varies from no load to a maximum load for all-channel driving depending on images to be displayed in the centralized amplifier system, stable amplifier performance and a high through rate for performing all-channel driving within one cycle are required therefor.

Since the number of amplifiers is small in the centralized amplifier system, a layout area can be reduced and current consumption can be reduced. Therefore, the centralized amplifier system is used in devices each using a small-sized liquid crystal panel principally, such as a cellular phone, a digital camera, etc.

In the centralized amplifier system, however, the lengths of wirings between the individual amplifiers and their corresponding source terminals greatly differ depending on the positions of the source terminals where another circuit block 108 such as a power circuit is disposed in addition to a circuit block 106 for the amplifiers as shown in FIG. 13. This results in the difference between wiring resistances 110 and thereby lead to unevenness in gradation. In a source terminal s1 close to the amplifiers and a source terminal s960 farthest therefrom as shown in FIG. 13, for example, the source terminal s1 reaches a desired voltage within 1 cycle for image writing even when the same gradation voltage is outputted, whereas the source terminal s960 might not reach the desired voltage within 1 cycle. This appears as unevenness in gradation.

FIG. 14 has shown, for example, output voltage waveforms v1 and v960 of the source terminals s1 and s960, a gate voltage p1 of a MOS-FET 104p of an amplifier a1, and an output voltage waveform vk1 of an output terminal k1 of the amplifier a1 at the time that the highest gradation voltage tap1 is applied to the source terminals s1 and s960. When the output voltage waveforms v1 and v960 are compared, the output voltage waveform v960 is lower than the output voltage waveform v1 in voltage upon completion of one cycle as shown in the same figure. This leads to unevenness in gradation.

Since the load of each amplifier greatly varies depending on an image as described above where the centralized amplifier system is used, the through rate of the amplifier falls short with respect to the maximum load. When, however, the drive capacity of the amplifier is excessively increased to make up for it, stability might be impaired like oscillations produced in the case of no load and the like. Therefore, although the distributed amplifier system is generally almost used in an amorphous silicon TFT and a low-temperature polysilicon TFT used in a QVGA or more size, the distributed amplifier system causes a problem such as an increase in the current consumption as described above.

### SUMMARY OF THE INVENTION

The present invention has been proposed to solve the above problems. It is an object of the present invention to provide an LCD panel driving circuit capable of suppressing unevenness in gradation even in a centralized amplifier system.

According to a first aspect of the invention, for attaining the above object, there is provided an LCD panel driving circuit comprising:

amplifier groups each of which outputs gradation voltages different from one another and comprises amplifiers corresponding to a predetermined number of gray levels;

gradation voltage output terminal groups each of which applies gradation voltages corresponding to images to liquid crystal pixels of an LCD panel of a predetermined size greater than or equal to a QVGA size and comprises gradation voltage output terminals greater than the predetermined number of gray levels and equivalent to the number corresponding to the predetermined size; and

decoder groups respectively comprising decoders each of which selects the gradation voltage corresponding to each image out of the gradation voltages outputted from the amplifier group and outputs the same to the corresponding gradation voltage output terminal,

wherein the gradation voltage output terminal groups and the decoder groups are respectively sectioned into plural form, and the amplifier groups are provided every section.

According to a second aspect of the invention, for attaining the above object, there is provided an LCD panel driving circuit comprising:

amplifier groups each of which outputs gradation voltages different from one another and comprises amplifiers corresponding to a predetermined number of gray levels;

gradation voltage output terminal groups each of which applies gradation voltages corresponding to images to liquid crystal pixels of an LCD panel of a predetermined size and comprises gradation voltage output terminals greater than the predetermined number of gray levels and equivalent to the number corresponding to the predetermined size; and

decoder groups respectively comprising decoders each of which selects the gradation voltage corresponding to each image out of the gradation voltages outputted from the amplifier group and outputs the same to the corresponding gradation voltage output terminal,

wherein the gradation voltage output terminal groups and the decoder groups are respectively sectioned into plural form, and the amplifier groups are provided every section.

According to the inventions described in the first and second aspects, gradation voltage output terminal groups and decoder groups are sectioned into plural form, and amplifier groups are provided every section. An LCD panel is driven for each section by a centralized amplifier system. Thus, since a load per amplifier is brought to 1/number of sections although current consumption increases as compared with the conventional centralized amplifier system, unevenness in gradation can be suppressed and a through rate can be improved.

According to a third aspect of the invention, the outputs of the amplifiers for outputting gradation voltages identical in gray level or gradation, of a plurality of the amplifier groups may respectively be connected to one another. It is thus possible to suppress unevenness in gradation between sections.

According to a fourth aspect of the invention, the amplifiers of the respective amplifier groups may respectively be disposed in the same row in accordance with a predetermined order.

According to a fifth aspect of the invention, for attaining the above object, there is provided an LCD panel driving circuit comprising:

amplifier groups each of which outputs gradation voltages different from one another and comprises amplifiers corresponding to a predetermined number of gray levels;

gradation voltage output terminal groups each of which applies gradation voltages corresponding to images to liquid crystal pixels of an LCD panel of a predetermined size greater than or equal to a QVGA size and comprises gradation voltage output terminals greater than the predetermined number of gray levels and equivalent to the number corresponding to the predetermined size;

decoder groups respectively comprising decoders each of which selects the gradation voltage corresponding to each image out of the gradation voltages outputted from the amplifier group and outputs the same to the corresponding gradation voltage output terminal; and

sub-amplifiers provided every amplifier, each of which assists the output of the amplifier where a load of the amplifier is brought to a predetermined magnitude.

According to a sixth aspect of the invention, for attaining the above object, there is provided an LCD panel driving circuit comprising:

amplifier groups each of which outputs gradation voltages different from one another and comprises amplifiers corresponding to a predetermined number of gray levels;

gradation voltage output terminal groups each of which applies gradation voltages corresponding to images to liquid crystal pixels of an LCD panel of a predetermined size and comprises gradation voltage output terminals greater than the predetermined number of gray levels and equivalent to the number corresponding to the predetermined size;

decoder groups respectively comprising decoders each of which selects the gradation voltage corresponding to each image out of the gradation voltages outputted from the amplifier group and outputs the same to the corresponding gradation voltage output terminal; and

sub-amplifiers provided every amplifier, each of which assists the output of the amplifier where a load of the amplifier is brought to a predetermined magnitude.

According to the fifth and sixth aspects, each amplifier is provided with a sub-amplifier for assisting the output thereof. Since each sub-amplifier assists the output of the amplifier only when the load of the amplifier is brought to a predetermined magnitude, unevenness in gradation can be suppressed and needless current consumption can be suppressed or cut down.

According to a seventh aspect of the invention, each of the sub-amplifiers may include a first amplifying stage including a first p channel MOS-FET and a first current source, a second amplifying stage including a first n channel MOS-FET and a second current source, and a CMOS circuit comprising a second p channel MOS-FET connected to the first p channel MOS-FET, and a second n channel MOS-FET connected to the first n channel MOS-FET.

According to an eighth aspect of the invention, each of the amplifiers may be disposed with being interposed between the sub-amplifiers. It is thus possible to supply a voltage to each gradation voltage output terminal uniformly.

According to a ninth aspect of the invention, the predetermined number of gray levels may be identical to the number of gray levels displayable in the LCD panel.

According to a tenth aspect of the invention, the LCD panel may be driven by the single LCD panel driving circuit.

According to an eleventh aspect of the invention, each of the decoder groups may be comprised of decoders identical to the gradation voltage output terminals in number.

According to a twelfth aspect of the invention, each of the gradation voltage output terminal groups may comprise the gradation voltage output terminals of 960 or more.

According to the present invention as described above, an advantageous effect is brought about in that unevenness in gradation can be suppressed even by a centralized amplifier system.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a configuration diagram of an LCD device according to a first preferred embodiment of the present invention;

FIG. 2 is a configuration diagram of a source driver according to the first preferred embodiment;

FIG. 3 is a configuration diagram showing decoders and bus wirings;

FIG. 4 is a diagram illustrating voltage waveforms or the like outputted to source terminals;

FIG. 5 is a configuration diagram of a modification of the source driver according to the first preferred embodiment;

FIG. 6 is a configuration diagram of a source driver according to a second preferred embodiment of the present invention;

FIG. 7 is a configuration diagram of a sub-amplifier;

FIG. 8 is a diagram illustrating voltage waveforms or the like outputted to source terminals at heavy loading;

FIG. 9 is a diagram illustrating voltage waveforms or the like outputted to the source terminals at light loading;

FIG. 10 is a configuration diagram of a source driver employed in a conventional distributed amplifier system;

FIG. 11 is a configuration diagram of a source driver employed in a conventional centralized amplifier system;

FIG. 12 is a configuration diagram of an amplifier;

FIG. 13 is a configuration diagram of a source driver employed in a conventional centralized amplifier system; and

FIG. 14 is a diagram illustrating voltage waveforms or the like outputted to source terminals by the conventional centralized amplifier system.

### DETAILED DESCRIPTION OF THE PREFERRED EMBODIMENTS

Preferred embodiments of the present invention will hereinafter be described in detail with reference to the accompanying drawings.

### First Preferred Embodiment

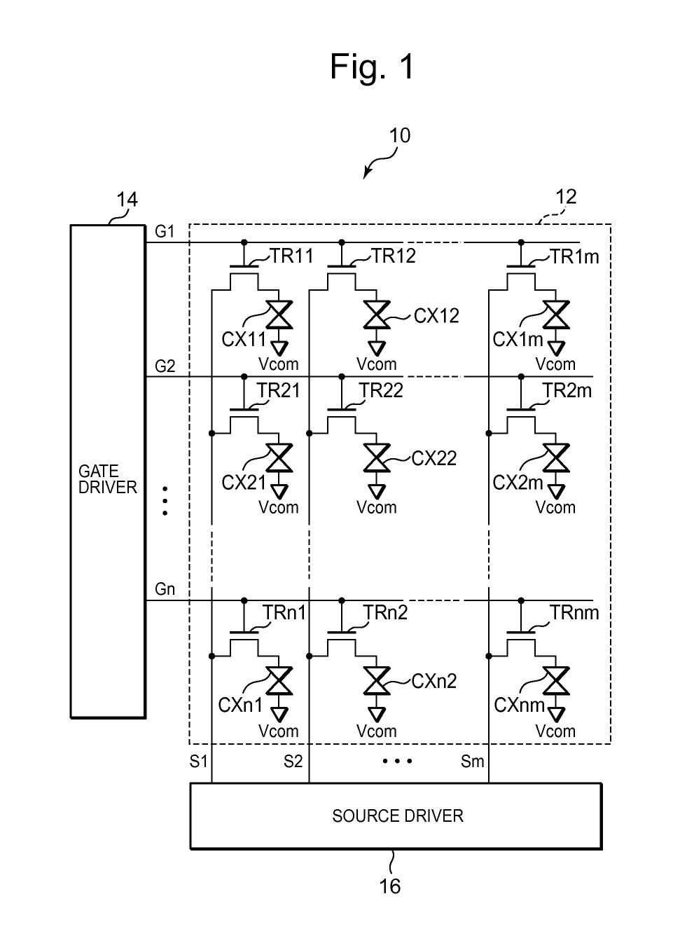

FIG. 1 is a circuit configuration diagram showing an LCD device according to a first preferred embodiment of the present invention. The LCD device 10 comprises an LCD (Liquid Crystal Display) panel 12, a gate driver 14 and a source driver 16.

The LCD panel 12 is driven by the gate driver 14 that drives n gate lines G1 through Gn and the source driver 16 that drives m source lines S1 through Sm. Incidentally, the gate driver 14 and the source driver 16 are respectively configured by single circuits, e.g., circuits formed on the same substrate. Namely, the LCD panel 12 is driven by the single gate and source drivers 14 and 16.

The LCD panel 12 has a configuration in which liquid crystal pixels constituted by switch transistors TR11 through TRnm, liquid crystal capacitances (liquid crystal pixels) CX11 through CXnm and common electrodes (not shown) to which a voltage level Vcom is applied, are arranged in matrix form. Each of the switch transistors is comprised of a TFT (Thin Film Transistor) in the present embodiment, but is not limited to it.

The source driver 16 outputs gradation voltages corresponding to a predetermined number of gray levels to the source lines S1 through Sm according to images. Incidentally, the predetermined number of gray levels is assumed to be 64 identical to the number of gray levels displayable in the LCD panel 12 by way of example. That is, the source driver 16 is capable of outputting gradation voltages corresponding to 64 levels to the source lines S1 through Sm respectively.

When a desired image is displayed on the LCD panel 12, the gate driver 14 sequentially brings the gate lines G1 through Gn to a high level. In sync with it, the source driver 16 sequentially outputs gradation voltages corresponding to images of rows equivalent to the gate lines respectively brought to the high level to the source lines S1 through Sm respectively, whereby the liquid crystal capacitances of the respective rows are sequentially charged so that the image is displayed on the LCD panel 12.

Incidentally, the present embodiment will explain, as one example, the LCD panel 12 as a color LCD having a QVGA size, i.e., a resolution of 320×240 size. Accordingly, the present embodiment will be explained with n=240 and m=960 (320×3 colors).

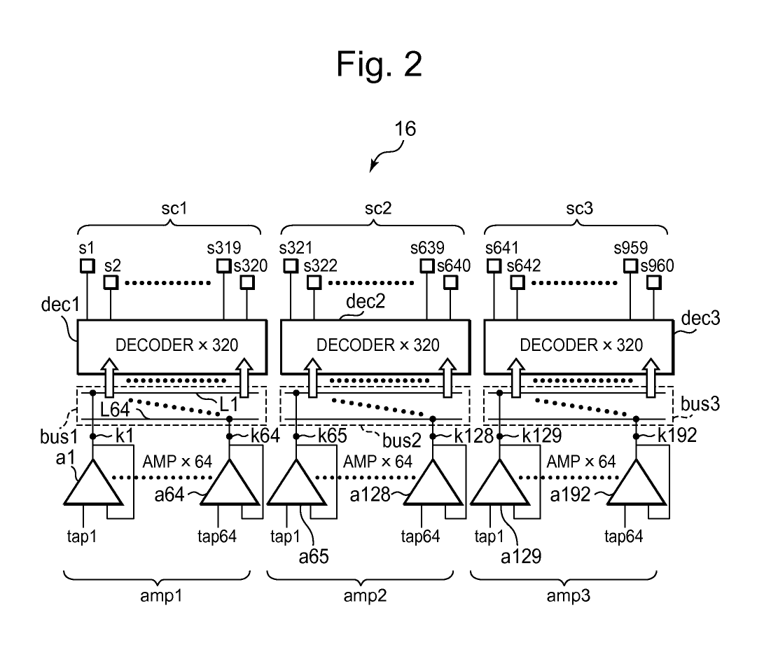

A specific configuration of the source driver 16 is shown in FIG. 2. The source driver 16 includes source terminals (gradation voltage output terminals) s1 through s960 provided at their corresponding source lines S1 through S960.

In the present embodiment, the source terminals s1 through s960 are partitioned or sectioned into three source terminal groups sc1 through sc3 of s1 through s320, s321 through s640 and s641 through s960 by way of example. Decoder groups dec1 through dec3, bus wirings bus1 through bus3 and amplifier groups amp1 through amp3 are respectively assigned to the source terminal groups sc1 through sc3 by ones.

The amplifier group amp1 comprises amplifiers a1 through a64 corresponding to the number of gray levels, i.e. sixty-four. One of gradation signals tap1 through tap64 of 64 levels outputted from an unillustrated gradation signal output circuit is inputted to each of the amplifiers a1 through a64. Incidentally, since a specific configuration of each amplifier is similar to that shown in FIG. 12, the description thereof will be omitted.

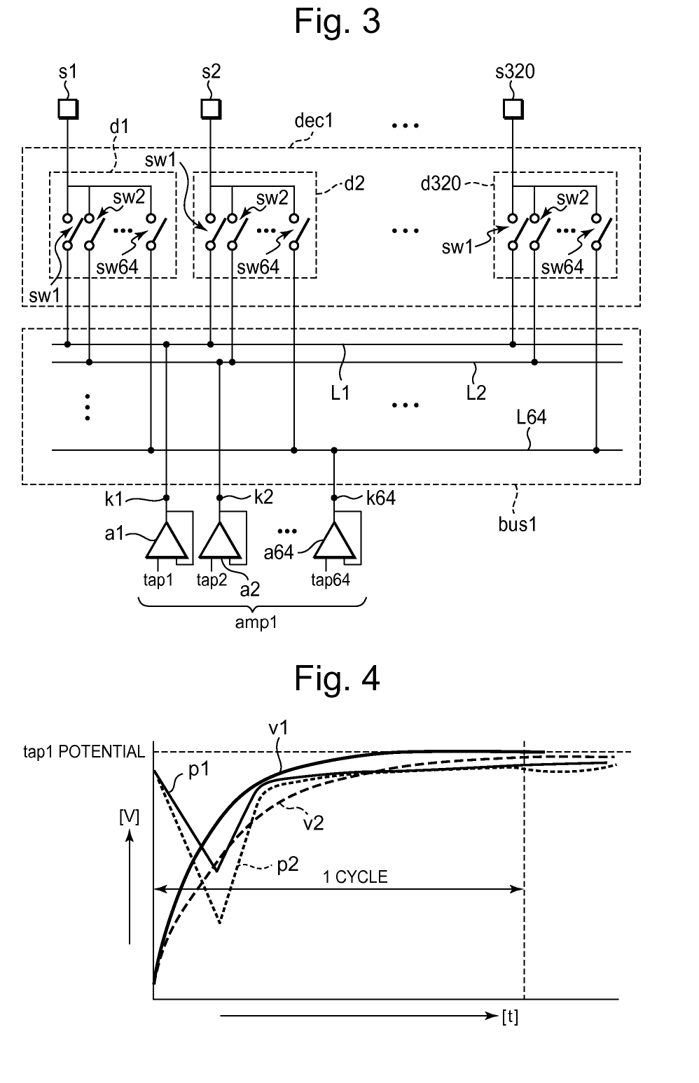

As shown in FIG. 3, the decoder group deal comprises 320 decoders d1 through d320 identical to the number of source terminals of the source terminal group sc1. Similarly, the decoder dec2 comprises decoders d321 through d640. The decoder dec3 comprises decoders d641 through d960.

Each decoder is comprised of switches sw1 through sw64. The bus wiring bus1 is made up of 64 wirings L1 through L64. The switches sw1 through sw64 of each decoder are respectively connected to the wrings L1 through L64. Output terminals k1 through k64 of the amplifiers a1 through a64 are also connected to their corresponding wirings L1 through L64.

Thus, when, for example, any of the switches sw1 through sw64 of the decoder d1 is selected and turned ON according to each image by an unillustrated controller, any of the output terminals k1 through k64 of the amplifiers is connected to the source terminal s1, so that a gradation voltage corresponding to the turned-ON switch is outputted to the source terminal.

Incidentally, since the amplifier groups amp2 and amp3, bus wirings bus2 and bus3 and decoder groups dec2 and dec3 are also similar to the amplifier group amp1, bus wiring bus1 and decoder group dec1, their detailed explanations are omitted. As shown in FIG. 2, the amplifiers of the respective amplifier groups are respectively disposed in the same row according to a predetermined order, that is, in the same row according to the order of the magnitudes of the gradation signals from tap1 to tap64.

In the present embodiment as described above, there is provided a configuration which should say also a distributed-centralized amplifier system in which the source terminals s1 through s960 and decoders d1 through d960 are respectively sectioned into three and the amplifier groups are provided every section. Therefore, the number of amplifiers can be reduced to ⅓ as compared with the conventional distributed amplifier system, and current consumption can hence be reduced greatly.

Since the load per amplifier is brought to ⅓, although current consumption increases as compared with the conventional centralized amplifier system, a through rate can be improved and the writing of an image into a high-load LCD panel is also enabled.

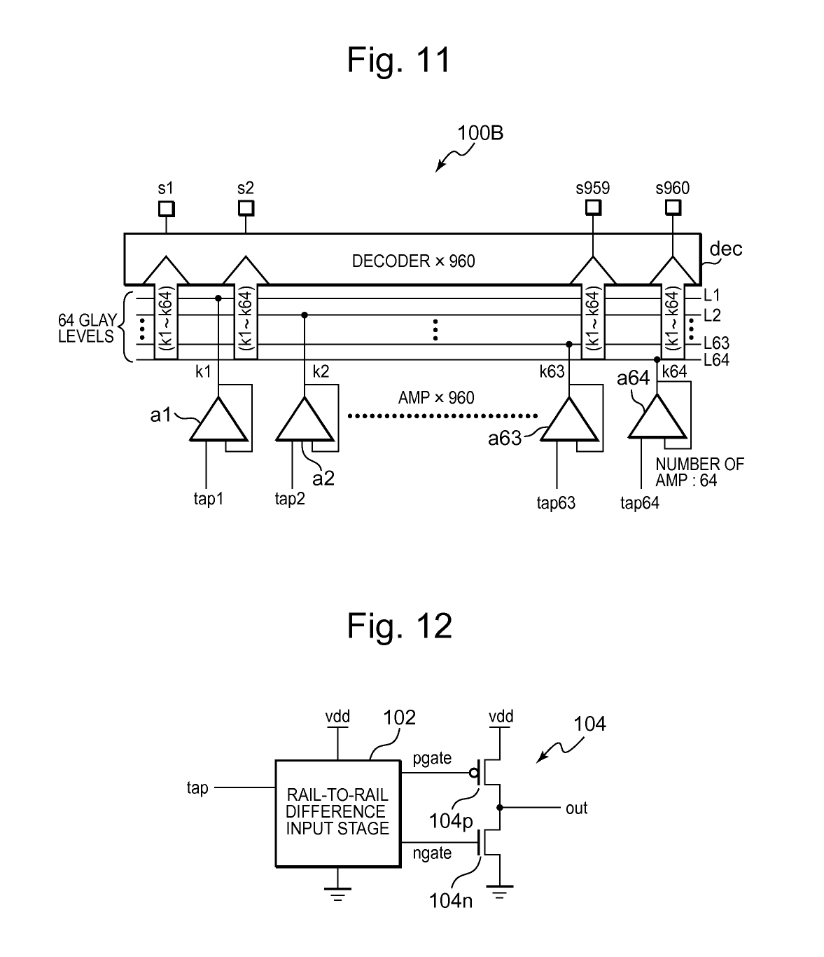

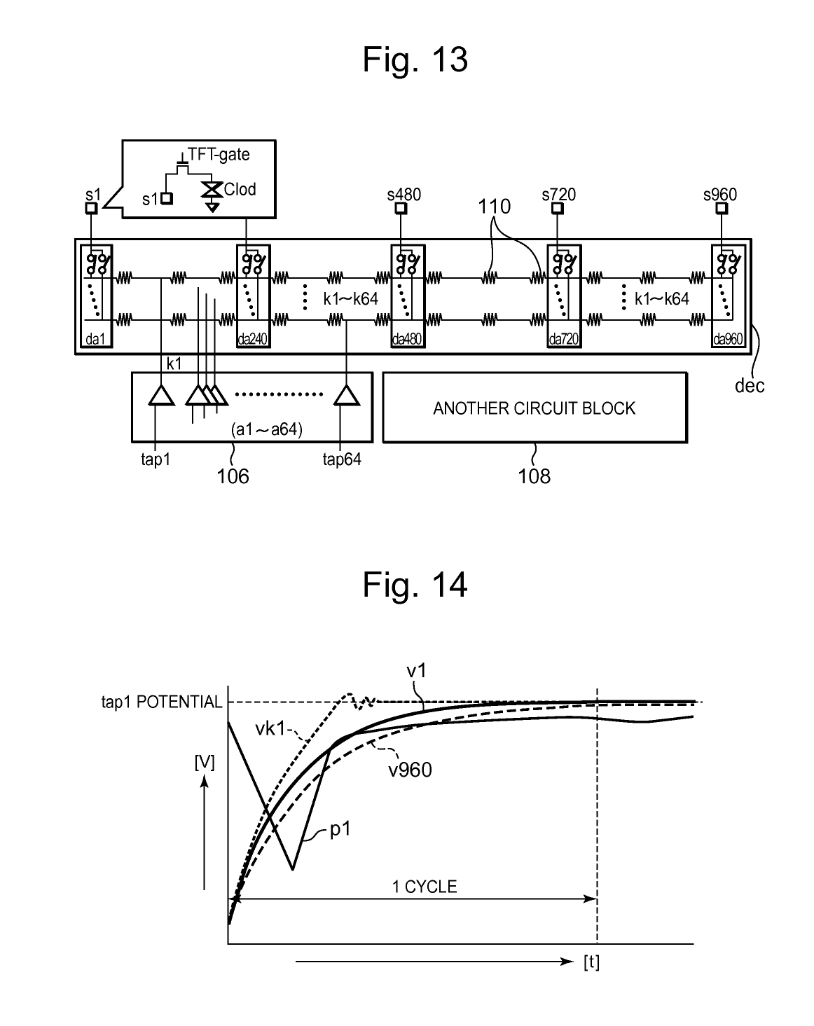

FIG. 4 has shown an output voltage waveform v1 of each of the source terminals s1, s321 and s641 and a gate voltage p1 of a MOS-FET 104p of the amplifier a1 at the time that the highest gradation voltage tap1 is applied to all of the source terminals s1 through s960 by the source driver 16 according to the present embodiment, and an output voltage waveform v2 of the source terminal s1 employed in the conventional circuit shown in FIG. 11 under the same condition and a gate voltage p2 of the p channel MOS-FET 104p of the amplifier a1 employed therein. It is understood that when the output voltage waveforms v1 and v2 are compared, the output voltage waveform v1 reaches the gradation voltage tap1 earlier than the output voltage waveform v2 and the through rate is improved as shown in the same figure.

On the other hand, although FIG. 2 has shown the configuration in which the sets of decoder groups, bus wirings and amplifier groups are provided as three sets, there is a case in which in the case of such a configuration, unevenness in gradation occurs between the respective sets where manufacturing errors or the like have occurred in the amplifiers even though the same gradation is outputted at the respective sets. When, for example, the gradation voltages tap1 are respectively outputted from the amplifiers a1, a65 and a129 to the source terminals s1 through s320, s321 through s640 and s641 through s960 that belong to the different sets, there is a case where variations occur in the output voltage waveforms between the respective sets, thereby causing unevenness in gradation.

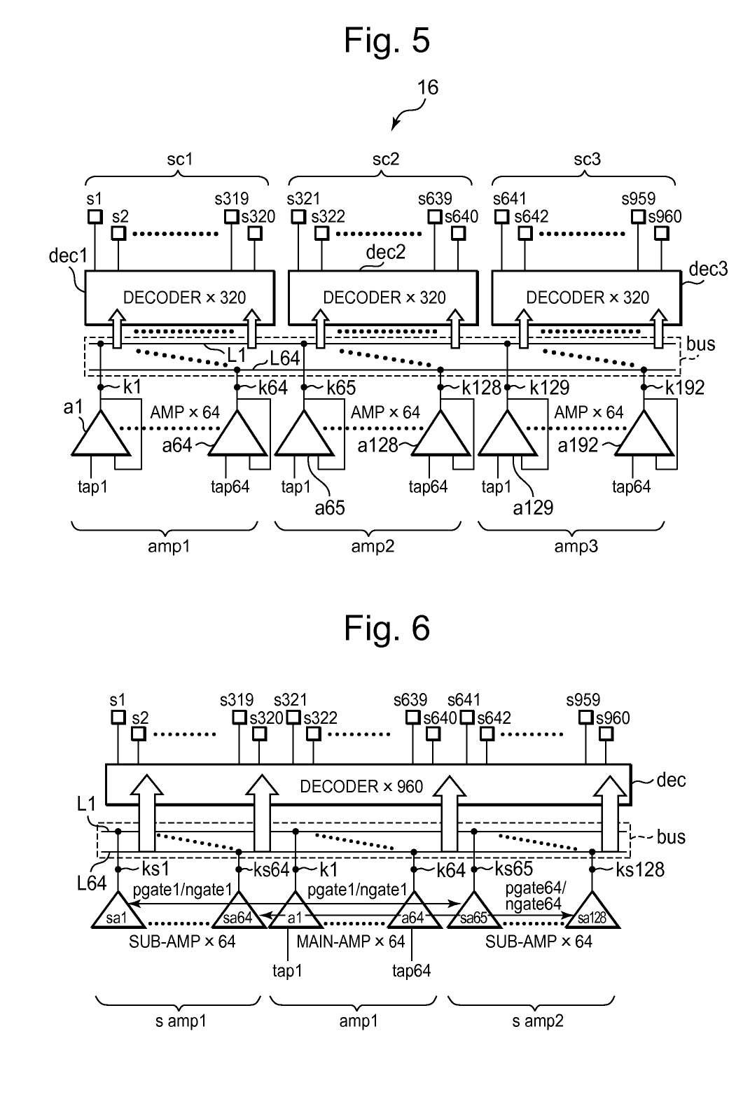

Thus, there may be provided such a configuration that as shown in FIG. 5, output terminals of amplifiers that output gradation voltages identical in gradation are respectively connected to one another, and a single bus wiring bus comprised of 64 wirings L1 through L64 is provided without dividing the bus wiring. Namely, for example, the output terminals k1, k65 and k129 of the amplifiers a1, a65 and a129 that output the gradation voltages identical in gradation are connected by the wiring L1. Even in the case of other amplifiers, their corresponding output terminals are connected in like manner.

It is thus possible to suppress unevenness in gradation between the respective sets. Since the gradation voltages are outputted from the three amplifiers to the source terminals, the through rate can be improved and an image can be written at high speed.

Incidentally, although the present embodiment has explained the case in which the source terminals are sectioned into the three, the present invention is not limited to it. The number of sections may be set to two or four or more. The more increase in the number of sections, the more the unevenness in gradation can be suppressed. When, however, the number thereof increases excessively, the number of amplifiers becomes too many to suppress current consumption so much. It is thus preferable to set the number of the sections to the number of such an extent that current consumption can also be suppressed while the unevenness of gradation is being suppressed, as compared with the conventional case.

### Second Preferred Embodiment

A second preferred embodiment of the present invention will next be explained. Incidentally, the same elements or components as those in the first preferred embodiment are identified by like reference numerals and their detailed description will therefore be omitted.

FIG. 6 shows an LCD device 10A according to the second preferred embodiment of the present invention. As shown in the same figure, the LCD device 10A comprises a decoder group dec comprised of 960 decoders similar to those shown in FIG. 11, a bus wiring bus similar to that shown in FIG. 5, an amplifier group amp1 similar to that shown in FIG. 5, a sub-amplifier group samp1 comprised of 64 sub-amplifiers sa1 through sa64 identical to amplifiers in number, and a sub-amplifier group samp2 comprised of sub-amplifiers sa65 through sa128.

The sub-amplifier sa1 of the sub-amplifier group samp1 and the sub-amplifier sa65 of the sub-amplifier group samp2 are assigned to the amplifier a1 to assist in its output. Output terminals ks1 and ks65 thereof are connected to a wiring L1 in a manner similar to an output terminal k1 of the main amplifier a1. The amplifiers a2 through a64 are also similar to the above and the two sub-amplifiers are allocated to each of the amplifiers.

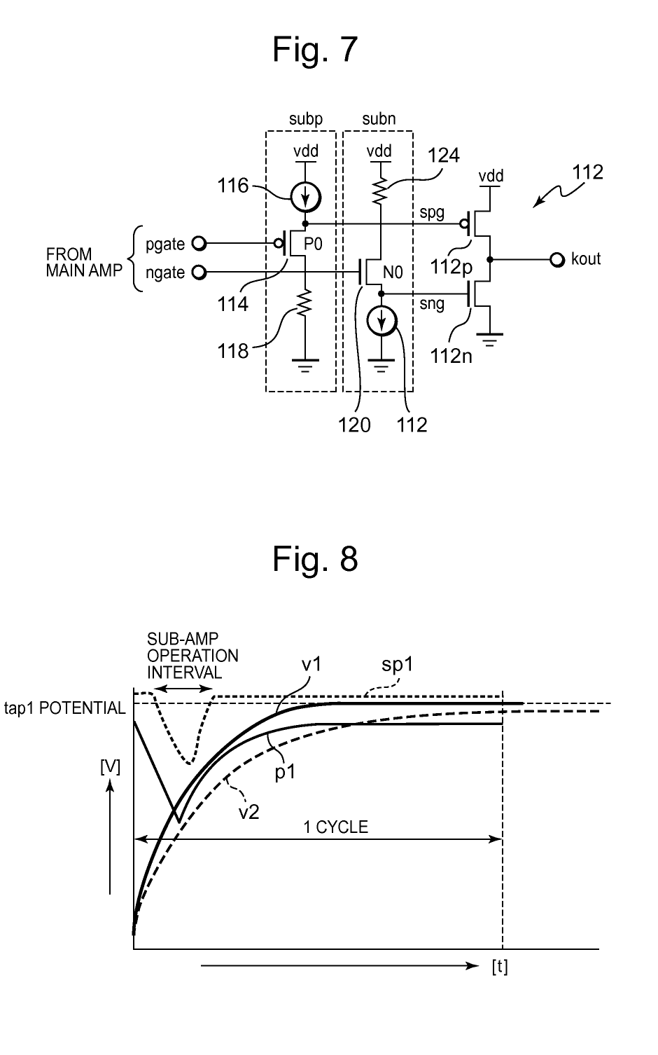

FIG. 7 shows a specific configuration of each sub-amplifier. The respective sub-amplifiers are identical in configuration. Each of the sub-amplifiers comprises two amplifying stages subp (first amplifying stage) and subn (second amplifying stage), and a CMOS circuit 112 comprising a p channel MOS-FET 112p (second p channel MOS-FET) and an n channel MOS-FET 112n (second n channel MOS-FET).

The amplifying stage subp comprises a p channel MOS-FET 114 (first p channel MOS-FET), a current source 116 and a resistor 118. The amplifying stage subn comprises an n channel MOS-FET 120 (first n channel MOS-FET), a current source 122 and a resistor 124.

The gate of the MOS-FET 114 is connected to its corresponding gate of a MOS-FET 104p of an associated main amplifier, and the gate of the MOS-FET 120 is connected to its corresponding gate of a MOS-FET 104n of the associated main amplifier.

A voltage applied to the gate of the MOS-FET 104p of each main amplifier is lowered as the load of the main amplifier increases. Namely, the magnitude of the load of the main amplifier correlates with the gate voltage of the MOS-FET 104p. Here, the load becomes large where, for example, a gradation voltage produced from each main amplifier is outputted to all source terminals.

In the two sub-amplifiers that assist the main amplifier, the constants or the like of respective elements that constitute the sub-amplifiers are determined in such a manner that when the load of the main amplifier reaches a predetermined magnitude or more and the gate voltage of the MOS-FET 104p reaches a predetermined value or less, the sub-amplifiers are operated, and that when the gate voltage of the MOS-FET 104p is less than the predetermined value, the outputs of the sub-amplifiers are brought to high impedance. Here, the predetermined value is set to a value capable of suppressing a reduction in the gradation voltage outputted to each source terminal, that is, suppressing unevenness of gradation if each sub-amplifier is operated where the gate voltage of the MOS-FET 104p is less than or equal to the predetermined value.

Thus, when the load of the main amplifier reaches the predetermined magnitude or more and the gate voltage of the MOS-FET 104p reaches less than the predetermined value, the respective sub-amplifiers are operated to assist the output of each main amplifier. It is therefore possible to suppress a reduction in the gradation voltage outputted to each source terminal and suppress unevenness in gradation. When the load of the main amplifier becomes less than the predetermined magnitude and the gate voltage of the MOS-FET 104p exceeds the predetermined value, the respective sub-amplifiers are not operated so that their outputs are brought to high impedance.

Thus, since the sub-amplifiers are operated only when the load of the main amplifier is heavy in the present embodiment, the through rate can be improved and needless current consumption can be suppressed. Since each amplifier is disposed so as to be interposed between the corresponding two sub-amplifiers in the present embodiment, the voltage can uniformly be supplied to the corresponding gradation voltage output terminal.

FIG. 8 has shown an output voltage waveform v1 of the source terminal s1, a gate voltage p1 of the MOS-FET 104p of the amplifier a1 and a gate voltage sp1 of the p channel MOS-FET 112p of the sub-amplifier sa1 at the time that the highest gradation voltage tap1 is applied to all of the source terminals s1 through s960 by the source driver 16 according to the present embodiment, and an output voltage waveform v2 of the source terminal s1 employed in the conventional circuit shown in FIG. 11 under the same condition. When the gate voltage p1 of the MOS-FET 104p of the main amplifier is greatly reduced to reach a predetermined value or less as shown in the same figure, the gate voltage sp1 of the MOS-FET 112p of the sub-amplifier is also reduced with its reduction so that the sub-amplifiers are operated. Thus, a gradation voltage is outputted to the source terminal s1 by the main amplifier and the two sub-amplifiers. Therefore, as is understood by a comparison between the output voltage waveforms v1 and v2, the output voltage waveform v1 reaches the gradation voltage tap1 earlier than the output voltage waveform v2, and the through rate can be improved.

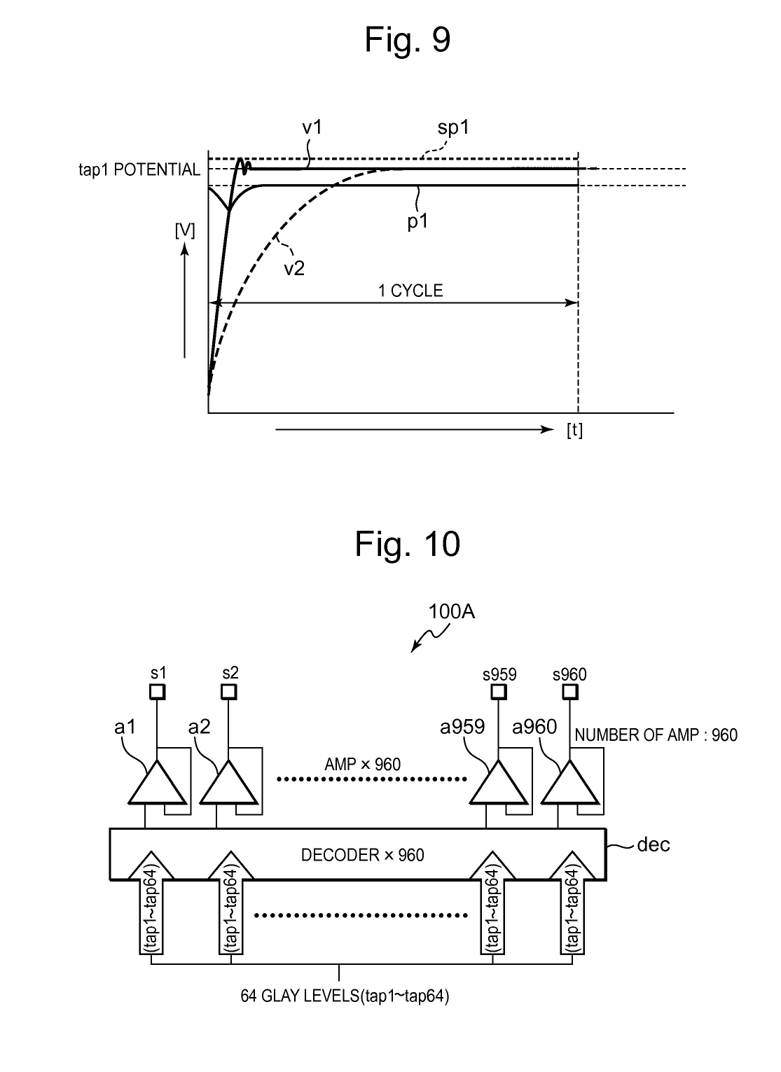

FIG. 9 has shown an output voltage waveform v1 of the source terminal s1, a gate voltage p1 of the p channel MOS-FET 104p of the amplifier a1 and a gate voltage sp1 of the p channel MOS-FET 112p of the sub-amplifier sa1 at the time that a gradation voltage tap1 is applied only to the source terminal s1 by the source driver 16 according to the present embodiment, and an output voltage waveform v2 of the source terminal s1 employed in the conventional circuit shown in FIG. 11 under the same condition. Since the driving of only one channel is performed, a reduction in the gate voltage p1 of the MOS-FET 104p of the main amplifier is small and the gate voltage p1 does not reach a predetermined value or less as shown in the same figure. Therefore, the gate voltage sp1 of the MOS-FET 112p of the sub-amplifier remains approximately constant and hence the sub-amplifiers are not operated. Thus, a gradation voltage is outputted to the source terminal s1 only by the main amplifier. Therefore, as is understood by a comparison between the output voltage waveforms v1 and v2, the output voltage waveform v1 reaches the gradation voltage tap1 earlier than the output voltage waveform v2, and the through rate can be improved. Further, since the sub-amplifiers are not operated, needless current consumption can be suppressed.

Incidentally, although the present embodiment has explained the case where the two sub-amplifier groups assist each main amplifier, the present invention is not limited to it, but may be set to one sub-amplifier group.

Although each of the above embodiments has explained the case in which the present invention is applied to the LCD panel of the QVGA size, the present invention is not limited to it, but is applicable even to LCD panels of a WQVGA (400×240) size, a VGA (640×480) size, etc. larger than the QVGA size.

The present invention brings about a noticeable effect in particular by application thereof to a driving circuit of an LCD panel of a QVGA size or more (the number of source terminals is 960 or more) at which the number of source terminals increases. It is however needless to say that the present invention is applicable even to an LCD panel of a QVGA size or less.

While the preferred forms of the present invention have been described, it is to be understood that modifications will be apparent to those skilled in the art without departing from the spirit of the invention. The scope of the invention is to be determined solely by the following claims.

1. An LCD panel driving circuit comprising:
amplifier groups each comprising amplifiers corresponding to a predetermined number of gray levels, said amplifier group outputting gradation voltages different from one another;
gradation voltage output terminal groups each comprising gradation voltage output terminals greater than the predetermined number of gray levels and equivalent to the number corresponding to a predetermined size greater than or equal to a QVGA size, said gradation voltage output terminal group applying gradation voltages corresponding to images to liquid crystal pixels of an LCD panel of the predetermined size; and
decoder groups respectively comprising decoders each of which selects the gradation voltage corresponding to each image out of the gradation voltages outputted from the amplifier group and outputs the same to the corresponding gradation voltage output terminal,
wherein the gradation voltage output terminal groups and the decoder groups are respectively sectioned into plural form, and the amplifier groups are provided every said section.

2. An LCD panel driving circuit comprising:
amplifier groups each comprising amplifiers corresponding to a predetermined number of gray levels, said amplifier group outputting gradation voltages different from one another;
gradation voltage output terminal groups each comprising gradation voltage output terminals greater than the predetermined number of gray levels and equivalent to the number corresponding to a predetermined size, said gradation voltage output terminal group applying gradation voltages corresponding to images to liquid crystal pixels of an LCD panel of the predetermined size; and
decoder groups respectively comprising decoders each of which selects the gradation voltage corresponding to each image out of the gradation voltages outputted from the amplifier group and outputs the same to the corresponding gradation voltage output terminal,
wherein the gradation voltage output terminal groups and the decoder groups are respectively sectioned into plural form, and the amplifier groups are provided every said section.

3. The LCD panel driving circuit according to claim 1 or 2, wherein the outputs of the amplifiers for outputting gradation voltages identical in gray level, of a plurality of the amplifier groups are respectively connected to one another.

4. The LCD panel driving circuit according to claims 1 or 2, wherein the amplifiers of the respective amplifier groups are respectively disposed in the same row in accordance with a predetermined order.

5. An LCD panel driving circuit comprising:
amplifier groups each comprising amplifiers corresponding to a predetermined number of gray levels, said amplifier group outputting gradation voltages different from one another;
gradation voltage output terminal groups each comprising gradation voltage output terminals greater than the predetermined number of gray levels and equivalent to the number corresponding to a predetermined size greater than or equal to a QVGA size, said gradation voltage output terminal group applying gradation voltages corresponding to images to liquid crystal pixels of an LCD panel of the predetermined size;
decoder groups respectively comprising decoders each of which selects the gradation voltage corresponding to each image out of the gradation voltages outputted from the amplifier group and outputs the same to the corresponding gradation voltage output terminal; and
sub-amplifiers provided every said amplifier, said each sub-amplifier assisting the output of the amplifier where a load of the amplifier is brought to a predetermined magnitude.

6. An LCD panel driving circuit comprising:
amplifier groups each comprising amplifiers corresponding to a predetermined number of gray levels, said amplifier group outputting gradation voltages different from one another;
gradation voltage output terminal groups each comprising gradation voltage output terminals greater than the predetermined number of gray levels and equivalent to the number corresponding to a predetermined size, said gradation voltage output terminal group applying gradation voltages corresponding to images to liquid crystal pixels of an LCD panel of the predetermined size;
decoder groups respectively comprising decoders each of which selects the gradation voltage corresponding to each image out of the gradation voltages outputted from the amplifier group and outputs the same to the corresponding gradation voltage output terminal; and
sub-amplifiers provided every said amplifier, said each sub-amplifier assisting the output of the amplifier where a load of the amplifier is brought to a predetermined magnitude.

7. The LCD panel driving circuit according to claim 5 or 6, wherein each of the sub-amplifiers includes:
a first amplifying stage including a first p channel MOS-FET and a first current source,
a second amplifying stage including a first n channel MOS-FET and a second current source, and
a CMOS circuit comprising a second p channel MOS-FET connected to the first p channel MOS-FET, and a second n channel MOS-FET connected to the first n channel MOS-FET.

8. The LCD panel driving circuit according to claims 5 or 6, wherein each of the amplifiers is disposed with being interposed between the sub-amplifiers.

9. The LCD panel driving circuit according to any one of claims 1, 2, 5 or 6, wherein the predetermined number of gray levels is identical to the number of gray levels displayable in the LCD panel.

10. The LCD panel driving circuit according to any one of claims 1, 2, 5 or 6, wherein the LCD panel is driven by a single said LCD panel driving circuit.

11. The LCD panel driving circuit according to any one of claims 1, 2, 5 or 6, wherein each of the decoder groups comprises decoders identical to the gradation voltage output terminals in number.

12. The LCD panel driving circuit according to any one of claims 1, 2, 5 or 6, wherein each of the gradation voltage output terminal groups comprises the gradation voltage output terminals of 960 or more.
Page 6 of 7
